(19) United States
(12) Patent Application Publication
(10) Pub. No.: US 2006/0268556 A1
(43) Pub. Date: Nov. 30, 2006

(54) LED shade

(76) Inventor: Chin-Mu Hsieh, Yungkang City (TW)

Correspondence Address: BACON & THOMAS, PLLC, 625 SLATERS LANE, FOURTH FLOOR, ALEXANDRIA, VA, 22314, US

(21) Appl. No.: 11/136,542

(22) Filed: May 25, 2005

(51) Int. Cl. F21V 7/00

(52) U.S. Cl. 362/347

(57) ABSTRACT

A light-emitting diode (LED) shade is used with an LED and has an opening, a concave cavity and multiple brackets. The concave cavity is defined in the LED shade, communicates with the openings and has an inner surface and multiple annular sets of convex mirrors formed coaxially on the inner surface. The brackets are formed on the outer surface. The multiple annular sets of convex mirrors efficiently reflect the light radiated by the LED mounted in the shade in an appropriate direction. The LED with the LED shade concentrates illumination.

### BACKGROUND OF THE INVENTION

1. Field of the Invention

The present invention relates to a light-emitting diode (LED) shade, and more particularly to an LED shade that has multiple sets of convex mirrors to efficiently reflect the light radiated by an LED mounted in the shade into an appropriate direction.

2. Description of Related Art

Light-emitting diodes (LEDs) are compact, light and energy-efficient and are used in many lighting apparatuses.

To concentrate the light radiated by an LED, the LED is used with a shade. The shade has a cavity in which the LED is mounted. The cavity has a curved inner specular surface to reflect and direct the light from the LED in an appropriate direction.

However, the concentrating effect of the curved specular surface for the light is not particularly effective, and the shade and the LED barely provide minimum illumination.

To overcome the shortcomings, the present invention provides an LED shade to mitigate or obviate the aforementioned problems.

### SUMMARY OF THE INVENTION

The main objective of the invention is to provide a light-emitting diode (LED) shade that has multiple sets of convex mirrors to efficiently reflect the light radiated by an LED mounted in the shade in an appropriate direction.

A light-emitting diode (LED) shade in accordance with the present invention is used with an LED and comprises a first opening, a second opening, a concave cavity and multiple brackets.

The concave cavity is defined in the LED shade, communicates with the openings and has an inner surface and multiple annular sets of convex mirrors formed coaxially on the inner surface.

The brackets are formed on the outer surface.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a light-emitting diode (LED) shade in accordance with the present invention;

FIG. 2 is a top view of the LED shade in FIG. 1;

FIG. 3 is a cross-sectional side view of the LED shade in FIG. 1 mounted on an LED;

FIG. 4 is a top view of two LED shades in FIG. 1 connected to each other;

FIG. 5 is a top view of four LED shades in FIG. 1 connected to each other in a square array; and

FIG. 6 is a top view of thirty-five LED shades in FIG. 1 connected to each other in a rectangular array.

### DETAILED DESCRIPTION OF PREFERRED EMBODIMENT

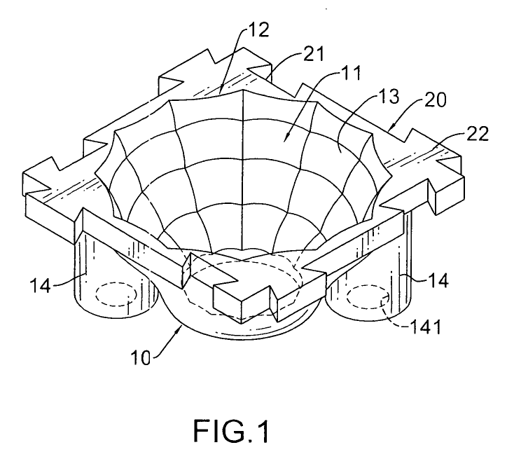

With reference to FIGS. 1 and 3, a light-emitting diode (LED) shade (10) in accordance with the present invention is used with an LED (30) connected to a circuit board, is annular and comprises an outer surface, an first opening, a second opening, a concave cavity (11), an outer edge (20) and multiple brackets (14).

The first opening allows the LED (30) to extend through the first opening and has a diameter. The second opening is opposite to the first opening, has a diameter larger than the diameter of the second opening and allows the light radiated by the LED (30) to pass through. The concave cavity (11) is defined in the LED shade (10), communicates with the first and second openings and has an inner surface (12) and multiple annular sets of convex mirrors (13). The annular sets of the convex mirrors (13) are formed coaxially on the inner surface (12). Each convex mirror (13) has a trapezoidal outline and is connected tightly to adjacent convex mirrors (13) without any gap. A preferred embodiment of each annular set of convex mirrors (13) has twelve convex mirrors (13).

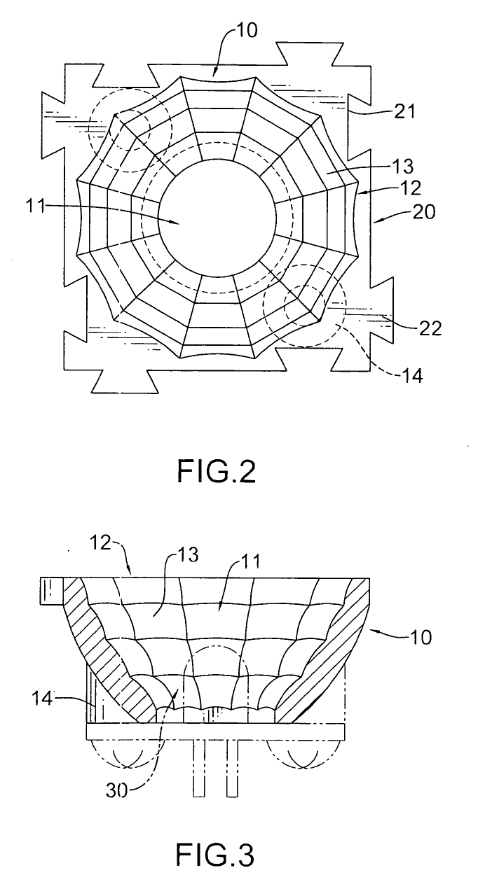

With further reference to FIG. 2, the outer edge (20) is polygonal, is formed around the concave cavity (11), has multiple straight edges and may be triangular, rectangular, pentagonal or the like so multiple LED shades (10) can form an array or a honeycomb. Each straight edge has at least one mortise (21) and at least one tenon (22). The at least one mortise (21) is defined perpendicularly in the straight edge. The at least one tenon (22) protrudes perpendicularly from the straight edge and corresponds to the at least one mortise (21) and may form a dovetail joint with the mortise (21).

The brackets (14) are formed on the outer surface of the LED shade (10) and are connected to the circuit board. Each bracket (14) may be cylindrical and has a distal end, a threaded hole (141) and a screw. The threaded hole (141) is defined longitudinally in the bracket (14) through the distal end. The screws extend through the circuit board and screw respectively into the threaded holes (141) to connect the LED shade (10) to the circuit board and to make the LED (30) be located in the concave cavity (11).

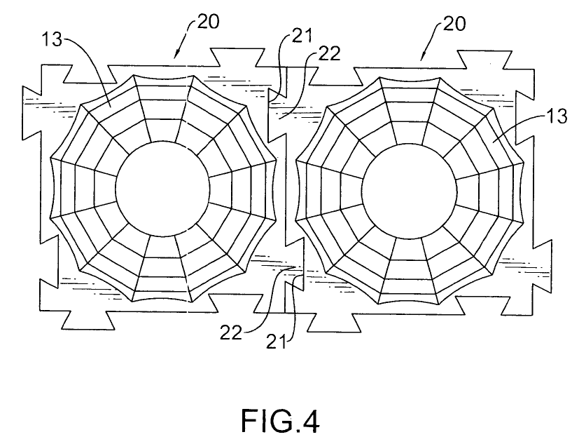

With reference to FIG. 4, multiple LED shades (10) can be mounted together and arranged in a line abreast to form a LED shade set.

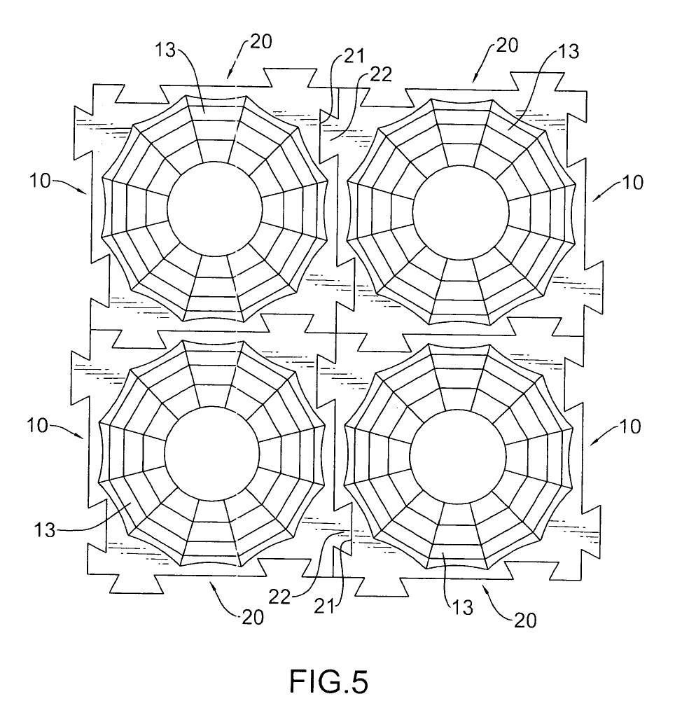

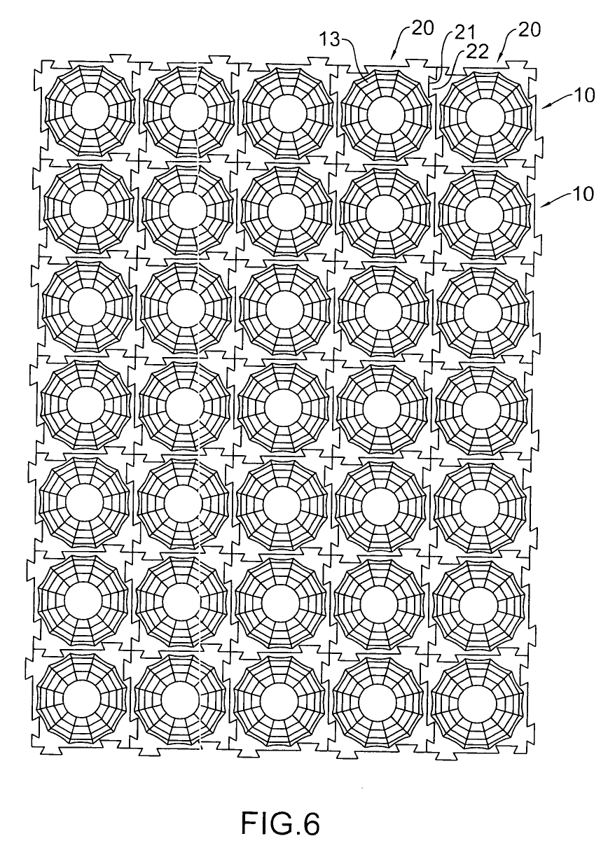

With reference to FIGS. 5 and 6, multiple LED shades (10) can be connected to each other in an array to form an LED shade set.

The multiple annular sets of convex mirrors (13) efficiently reflect light radiated by the LEDs (30) mounted in the shades in an appropriate direction. The LED (30) with the LED shade (10) radiates concentrated illumination.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light-emitting diode (LED) shade comprising:
an outer surface;
a first opening having a diameter;
a second opening being opposite to the first opening and having a diameter larger than the diameter of the first opening;
a concave cavity defined in the LED shade, communicating with the first and second openings and having
an inner surface; and
multiple annular sets of convex mirrors formed coaxially on the inner surface; and
an outer edge.

2. The LED shade as claimed in claim 1, wherein the outer edge is polygonal, is formed around the cavity and has multiple straight edges.

3. The LED shade as claimed in claim 2, wherein each straight edge of the outer edge has at least one mortise defined perpendicularly in the straight edge and at least one tenon protruding perpendicularly from the straight edge and corresponding to the at least one mortise.

4. The LED shade as claimed in claim 3, wherein the at least one mortise of each straight edge on the outer edge and the at least one tenon of each straight edge on the outer edge form a dovetail joint.

5. The LED shade as claimed in claim 4, each convex mirror has a trapezoidal outline and connecting tightly to adjacent convex mirrors.

6. The LED shade as claimed in claim 5, wherein a number of the convex mirror of each set is twelve.

7. The LED shade as claimed in claim 6 further has multiple brackets formed on the outer surface.

8. The LED shade as claimed in claim 7, wherein each bracket is cylindrical and has a distal end and a threaded hole defined longitudinally in the bracket through the distal end.
